(19) United States
(12) Patent Application Publication
(10) Pub. No.: US 2012/0165993 A1
(43) Pub. Date: Jun. 28, 2012

(54) Self-Programming Thermostat System, Method and Computer Program Product

(75) Inventor: Cameron Dean Whitehouse, Charlottesville, VA (US)

(73) Assignee: UNIVERSITY OF VIRGINIA PATENT FOUNDATION, Charlottesville, VA (US)

(21) Appl. No.: 13/284,448

(22) Filed: Oct. 28, 2011

Related U.S. Application Data
(60) Provisional application No. 61/407,551, filed on Oct. 28, 2010.

(51) Int. Cl. G05D 23/00

(52) U.S. Cl. 700/278

(57) ABSTRACT

Self-programmable thermostat control system and method that automatically senses, creates and suggests highly energy efficient optimized setback schedules in a controllable and predictable manner for a user in accordance with consistently updated historical occupancy patterns of a heated and/or cooled space. Through the use of this system and method, users will be able to reduce inefficiency from the setback schedules produced by other thermostats and select one of the many energy efficient setback schedules produced by the system through an easy to use display screen built into the self-programmable thermostat. With this unique system and method, the user is able to customize their energy efficiency and comfort level in their cooled and/or heated space by selecting the set-back schedule that fits best with their pocketbook and comfort level all at the turn of a knob.

### RELATED APPLICATIONS

The present application claims priority from U.S. Provisional Application Ser. No. 61/407,551 filed Oct. 28, 2010, entitled “Self-Programming Thermostat System, Method and Computer Program Product;” the disclosure of which is hereby incorporated by reference herein in its entirety.

### FIELD OF THE INVENTION

The present invention relates to the field of self-programmable thermostats that react to occupancy data within the heated and/or cooled space. More specifically, the present invention relates to the field of optimizing temperature control within a space, based on historical occupancy data within the space.

### BACKGROUND OF THE INVENTION

Heating, ventilation, and air conditioning (HVAC) is the largest energy consumer in the home, accounting for 43% of all residential energy usage. Programmable thermostats can substantially reduce this energy usage with a setback schedule that relaxes temperature setpoints at certain times of the day, typically when the home is unoccupied or the occupants are sleeping. Consumers are often advised that programmable thermostats can reduce the energy needed to heat and cool a home by 10-30% without reducing comfort. However, choosing a setback schedule that achieves this goal can be challenging because people do not typically know the exact occupancy patterns of their home, especially when it has multiple occupants who come and go at different times. As a result, most people do not use optimal setback schedules for their home and suffer from increased energy bills or decreased comfort. It is because of these inconsistent occupancy patterns, that attempts have been made to try to help consumers through the creation of self-programmable thermostats that automatically sense the occupancy statistics for the user and automatically shut on or off the system based on these statistics.

However, these related, yet fundamentally different, systems often result in startling inefficiencies due to their algorithms and methodologies being premised upon real-time reactive sensing data rather than retrospectively accumulated sensing data. These real-time, reactive based programmable thermostats cause a tremendous amount of false positives as the system reacts defensively and automatically to consistently varying occupancy statistics—never analyzing or learning the patterns of these varying occupancy statistics over the long-run to reduce these inefficiencies. Because of this consistent and responsive on-and-off of the system due to varying occupancy data, these seemingly flexible systems hold their users hostage by automatically shutting on and off the system without the user's input and deliver quite perverse outcomes, in terms of energy efficiency and energy cost.

Therefore, there exists, a need in the art for a non-reactive or offensive system and method of controlling a HVAC system in a heated and/or cooled space through controllable and predictable setback schedules that can be easily tailored and optimized by the user depending on the user's comfort and tolerance for inefficient energy waste.

### SUMMARY OF THE INVENTION

An aspect of an embodiment of the present invention provides a self-programming thermostat that automatically generates a selection of optimal setback schedules for the user to easily select by sensing the occupancy statistics of a home. The system and method monitors occupancy using detecting means. Generally these detecting means will be occupancy sensors placed throughout the heated and/or cooled space; however the detecting means can include a number of other indicators such as motion detectors or water usage detectors placed throughout the heated and/or cooled space in order to give an effective reading on the occupancy in the space. The optimal setback schedule or selection of optimal setback schedules is then generated and conveniently shown to the user for selection, together with the expected impact of the schedule in terms of comfort, energy usage, environmental impact, or other considerations. After generating this menu of optimized set back schedules premised on the historical occupancy patterns of the space, the user can choose the setback schedule that best matches their desired balance between energy, comfort, and other considerations. Furthermore, the setback schedule creation can either be on-line or off-line, and can either be automated or can involve a human operator. The schedule and occupancy can either be used to save energy for the heated/or and cooled space, to estimate other ways energy could be saved in the heated and/or cooled space, or to estimate why energy is or is not being saved in the heated and/or cooled space.

Another aspect of an embodiment of the present invention is to estimate the building usage and HVAC settings caused by occupant choice, in order to understand how occupant choice affects energy consumption. Occupant choice has been estimated to affect up to 80% of all energy usage in a building, thereby adding high variability and uncertainty to a building's performance. The occupancy information and schedule could be used to make recommendations other than thermostat schedules, or to provide building performance guarantees that factor out the effect of occupant choice.

An aspect of an embodiment of the present invention provides for a self-programmable thermostat control system, method and computer program product that automatically senses, creates, and suggests highly energy efficient optimized setback schedules in a controllable and predictable manner for a user in accordance with consistently updated historical occupancy patterns of a heated and/or cooled space. Through the use of this system and method, users will be able to reduce inefficiency from the setback schedules produced by other thermostats and select one of the many energy efficient setback schedules produced by the system through an easy to use display screen built into the self-programmable thermostat. With this unique system and method, the user is able to customize their energy efficiency and comfort level in their cooled and/or heated space by selecting the set-back schedule that fits best with their economic interests (e.g., pocketbook) and comfort level all at the turn of a knob.

An aspect of an embodiment of the present invention provides, among other things, a non-reactive or offensive system and method of controlling a HVAC system in a heated and/or cooled space through controllable and predictable setback schedules that can be easily tailored and optimized by the user depending on the occupant's or user's comfort and tolerance for inefficient energy waste.

An aspect of an embodiment of the present invention provides a self-programming thermostat control system that automatically senses, creates and/or suggests highly energy efficient and optimized setback schedules for controlling energy consumption within a space in a controllable and predictable manner for a user in accordance with consistently changing historical occupancy patterns of a space. The system may comprise: a) detecting means for detecting the occupancy rates; b) timing means for capturing the time interval data; c) frequency means for determining the rate and consistency at which these detecting means detect varying occupancy rates at these different time intervals that correspond with different user-based activity functions; d) storage means for aggregating historical occupancy rates generated by the detecting means in conjunction with the timing and frequency means; e) programming means for reading, analyzing, and modeling the collected historical occupancy rates from the detecting means at changing times and frequencies using the timing and frequency means to derive occupancy pattern models that are used to generate and suggest a selection of efficient setback schedules that can be optimized by the user for greater energy efficiency and comfort in a space; and f) display means that display a selection of optimal setback schedules generated by using the detecting, timing, frequency, and programming means of the system; that displays information to the user that balances energy usage and comfort; and that contains a selection means which allows a user to choose from the selection of optimal setback schedules for use in the space.

An aspect of an embodiment of the present invention provides a method for a self-programming thermostat that automatically creates optimal setback schedules by detecting varying occupancy statistics of a space to achieve greater energy efficiency and comfort for an occupant. The method may comprise: a) selecting an initial baseline setback schedule that is defined by occupant; b) detecting the occupancy rates of the heated and/or cooled space throughout the cooled and/or heated space over the course of a time interval to generate occupancy patterns, which is defined by activity parameters; c) consistently detecting and logging variance in the occupancy rates by the occupant at the defined activity parameters and labeling it miss time; d) using the miss time to calculate an average miss time over the course of the time interval; e) creating gradually shrinking setback schedules that gradually minimize the miss time; and f) suggesting a selection of at least two setback schedules with the least the average miss time to the user in an easy to use display model interface with different energy and comfort tradeoffs shown.

An aspect of an embodiment of the present invention provides a self-programming thermostat control system that automatically creates and/or suggests highly energy efficient and optimized setback schedules for controlling energy consumption within a space in a controllable and predictable manner intended for a user accordance with consistently changing historical occupancy patterns of a heated and/or cooled space, wherein the system is configured to receive a) occupancy rates associated with different activity functions within the desired heated and/or cooled space and b) captured time intervals when the change of occupancy occurs in the heated and/or cooled space. The system may further comprise: a) frequency means for determining the rate and consistency of the received occupancy rates at the captured time intervals that correspond with different user-based activity functions; b) storage means for aggregating historical occupancy rates generated by the detecting means in conjunction with the timing and frequency means; c) programming means for reading, analyzing, and modeling the collected historical occupancy rates from the detecting means at changing times and frequencies using the timing and frequency means to derive occupancy pattern models that are used to generate and suggest a selection of efficient setback schedules that can be optimized by the user for greater energy efficiency and comfort in a space; and d) display means that display a selection of optimal setback schedules generated by using the detecting, timing, frequency, and programming means of the system; that displays information to the user that balances energy usage and comfort; and that contains a selection means which allows a user to choose from the selection of optimal setback schedules for use in the space.

An aspect of an embodiment of the present invention provides a computer program product comprising a non-transitory computer useable medium having a computer program logic for enabling at least one processor in a computer system to automatically create optimal setback schedules to achieve greater energy efficiency and comfort for an occupant. The computer program logic may comprising: a) receiving a selected initial baseline setback schedule; b) receiving detected occupancy rates of the heated and/or cooled space throughout the cooled and/or heated space over the course of a time interval to generate occupancy patterns, which is defined by activity parameters; c) receiving detected and logged variance in the occupancy rates by the occupant at the defined activity parameters and labeling it miss time; d) using the miss time to calculate an average miss time over the course of the time interval; e) creating gradually shrinking setback schedules that gradually minimize miss time; and f) suggesting a selection of at least two setback schedules with the least the average miss time to the user in an easy to use display model interface with different energy and comfort tradeoffs shown.

An aspect of an embodiment of the present invention provides a self-programming thermostat control system that automatically senses, creates and/or suggests highly energy efficient and optimized setback schedules for controlling energy consumption within a space in a controllable and predictable manner for a user in accordance with consistently changing historical occupancy patterns of a space. The system comprises: a) a detector, the detector detects occupancy rates; b) a timer for capturing the time interval data and for determining the rate and consistency at which the detector detects varying occupancy rates at these different time intervals that correspond with different user-based activity functions; c) storage for aggregating historical occupancy rates generated by the detector in conjunction with corresponding the time intervals; d) a computer processor for reading, analyzing, and modeling the collected historical occupancy rates from the detector at changing times and frequencies using the timer to derive occupancy pattern models that are used to generate and suggest a selection of efficient setback schedules that can be optimized by the user for greater energy efficiency and comfort in a space; and e) a display device that displays a selection of optimal setback schedules generated by using the detecting, timing, frequency, and programming means of the system; that displays information to the user that balances energy usage and comfort, and provides a selection mechanism that allows a user to choose from the selection of optimal setback schedules for use in the space.

An aspect of an embodiment of the present invention provides a self-programming thermostat control system that automatically creates and suggests highly energy efficient and optimized setback schedules for controlling energy consumption within a space in a controllable and predictable manner intended for a user accordance with consistently changing historical occupancy patterns of a heated and/or cooled space, wherein the system is configured to receive a) occupancy rates associated with different activity functions within the desired heated and/or cooled space and b) captured time intervals when the change of occupancy occurs in the heated and/or cooled space. The system may further comprise: a) timer for determining the rate and consistency of the received occupancy rates at the captured time intervals that correspond with different user-based activity functions; b) storage for aggregating historical occupancy rates; c) processor for reading, analyzing, and modeling the collected historical occupancy rates to derive occupancy pattern models that are used to generate and suggest a selection of efficient setback schedules that can be optimized by the user for greater energy efficiency and comfort in a space; and d) display unit that displays a selection of optimal setback schedules that displays information to the user that balances energy usage and comfort, and that contains a selection mechanism that allows a user to choose from the selection of optimal setback schedules for use in the space.

An aspect of an embodiment of the present invention may includes implementing available techniques and approaches for manufacturing any of the components, modules, devices and systems discussed throughout this disclosure.

These and other objects, along with advantages and features of various aspects of embodiments of the invention disclosed herein, will be made more apparent from the description, drawings and claims that follow.

### BRIEF DESCRIPTION OF THE DRAWINGS

The accompanying drawings, which are incorporated into and form a part of the instant specification, illustrate several aspects and embodiments of the present invention and, together with the description herein, serve to explain the principles of the invention. The drawings are provided only for the purpose of illustrating select embodiments of the invention and are not to be construed as limiting the invention.

FIG. 1 shows a functional block diagram for a computer system for implementation of an exemplary embodiment or portion of an embodiment of present invention.

FIG. 2 shows a schematic block diagram of the self-programming thermostat system in an embodiment of the invention.

FIG. 3A shows a schematic block diagram that represents an embodiment of the self-programming thermostat display, with a knob as the selection means.

FIG. 3B shows a schematic block diagram that represents an embodiment of the self-programming thermostat display, with a slidebar as the selection means.

FIG. 4 shows the illustrative steps of the method (or corresponding software/hardware/firmware modules) of automatically creating optimal setback schedules by detecting varying occupancy statistics of a space to achieve greater or maximum energy efficiency and comfort for an occupant.

### DETAILED DESCRIPTION OF THE PREFERRED EMBODIMENTS

An aspect of an embodiment of the present invention provides a self-programming thermostat system and method that aims to conserve energy and maximize or increase comfort in a building by sensing occupancy and optimizing the setback schedule accordingly. In one embodiment, the system and method does not modify the temperature setpoints chosen by the user; it only helps the user choose the optimal times at which these setpoints should take effect by providing a selection of temperature setback schedules to the user. The self-programming thermostat allows the user to choose a schedule, by searching through a selection of optimal setback schedules. As the user looks at this selection of schedules, the system presents the times and temperatures of each schedule along with estimates of their energy usage, comfort, and environmental or societal impact. The user can then choose the schedule that meets his or her desired balance of these criteria. As the occupancy patterns of the building change, the thermostat will update the selection of optimal schedules and will notify the user that substantial savings could be achieved by choosing a new schedule. In one embodiment of the invention, if the user declines to select a desired optimal setback schedule, the system will continue to operate on a default setback schedule. In another embodiment of the invention, if the user declines to select a desired optimal setback schedule, the system will select an optimal setback schedule.

In one embodiment of the invention, the self-contained, automated self-programming thermostat utilizes detection means in a heated and cooled space, including but not limited to infrared motion sensors, infrared heat sensors, ultrasonic sensors, door sensors, water usage sensors, or light sensors. The system automatically collects the sensor data over a period of time, perhaps using a wireless connection or a connection through the building's security system, and automatically generates a selection of optimal setback schedules for the user to see. The user can scroll through these schedules using an easy-to-use selection means, such as a knob or slidebar, and is presented with the characteristics of each schedule based upon the accumulated historical occupancy data and patterns of the cooled and heated space. The user can choose to execute a new schedule and can override an existing schedule at any time, if they determine that they want a higher or lower level of comfort. This embodiment is self-contained much like modern programmable thermostats.

Monitoring of the heated and cooled space, creation of setback schedules, and control of the building's HVAC system can be performed on-line or off-line, and can be performed automatically or can involve a human operator. In one embodiment, the occupancy data is collected to a server where the data is analyzed, either by a human or automated program. Additionally, the choice of the optimal schedule can be made either by the user or by the system itself, and the selection means and optimal setback schedules can be displayed to the user either through an electronic console, an e-mail, a web page, a mobile phone communication, or via postal mail, email or text messaging. The system can be applied in many settings. The system user could be the occupant of a building, or an HVAC optimizing team, or a building manager (or any other type of personnel in connection or associated with the building or space). The occupancy information and schedule could be used by the occupants or managers of a building to save energy, or by a third-party to make recommendations on energy usage as part of an energy audit that includes and/or factors out occupancy statistics.

It should be appreciated that input may be provided by the user (or occupant) or by any type of computer processor instead of the user or in addition to the user.

An aspect of various embodiments of the present invention may be utilized for a number of products and services, such as but not limited thereto, the following:
an embodiment may be used to save energy in homes, businesses, factories, universities, vehicles (including aircrafts, or spaceships), or other dwellings.
an embodiment could also be converted into a service and residents, or building owners could be charged a monthly fee for the thermostat optimization service.

It should be appreciated that the system and related method may be implemented for multiple homes, businesses, factories, universities, vehicles, or other dwellings. Moreover, it should be appreciated that the system and related method may be implemented for multiple locations within each of the homes, businesses, factories, universities, vehicles, or other dwellings.

In contrast to most thermostats, an aspect of an embodiment of the present invention provides a self-programming thermostat that uses occupancy sensors. In contrast to other thermostatic systems that use occupancy sensors, an aspect of an embodiment of the present invention provides a self-programming thermostat that learns from historical occupancy to find occupancy patterns over a time period of that cooled and heated space. Furthermore, in contrast to other thermostatic systems that utilize occupancy sensors, an aspect of an embodiment of the present invention provides a self-programming thermostat that:
finds occupancy patterns within the accumulated historical occupancy data over a time period of the heated and cooled space;
produces a series of optimal static temperature schedules based on these patterns;
gives estimates of each schedule's impact on energy, comfort, the environment, and society; and
allows the user to easily see and select the setback schedule that best fits the user's needs.

A distinguishing feature of an embodiment of the present invention, among other things, is that the system is able to simultaneously produce three things:
an optimal or near-optimal schedule based on historical building occupancy,
accurate estimates of energy usage, comfort, environmental impact, and
A predictable and controllable operation that can be easily understood even by novice users.

While programmable thermostats allow occupants to control an HVAC system by scheduling different setpoint temperatures at various times throughout the day, it can be difficult for the homeowner to define setback schedules that match the occupancy patterns of the home, especially for homes with multiple occupants and irregular occupancy patterns. In a recent study, more than half of all homes reported not using setback schedules during unoccupied periods of the day or when occupants were sleeping. A goal of an aspect of an embodiment of the present invention is to automatically generate an optimal setback schedule of family of schedules for a heated and cooled space by empirically measuring constantly changing occupancy statistics. In contrast to conventional systems, an aspect of an embodiment of the present invention, the self-programming thermostat has a fixed schedule and is therefore more predictable and easier to use.

The system develops optimal temperature schedules by applying a unique algorithm (and method) to the collected historical occupancy data. Typically, the occupancy pattern of a typical home is constantly changing every day, and so any chosen setback schedule will unfortunately condition an empty home on some days or nights when it should not, a variable in the algorithm which is described as waste. Along the same lines, the selected setback schedule will unfortunately miss conditioning or heating an occupied home when it should because of this same variability, a variable in the algorithm which is described as miss time. The self-programming thermostat is unique because it allows the user to define the desired balance between energy and comfort using a miss time knob, which defines the maximum tolerance a user has for miss time in their home because of this variability in occupancy data. As the user turns the knob, the system displays the longest possible setback schedule that achieves the desired miss time. This interface allows the user to choose a miss time in a predictable and controllable manner with the desired balance between comfort and energy. This predictable and controllable interface allows the user to conserve more energy while sacrificing less in comfort all at the turn of a knob.

A goal of the self-programming thermostat is to, but not limited thereto, define a fixed setback schedule that minimizes miss time on average, given occupancy statistics. In an embodiment of the invention, the thermostat stores occupancy data over the course of n days by observing the time Tₗₑₐᵥₑ that the individual leaves from the home each day, and the time Tₐᵣᵣᵢᵥₑ that the individual arrives at the home. A suggested time period of n days for optimal efficiency may be about 7-70 days, or about 1-10 weeks, but it should be appreciated that it may vary as desired or required. From this data, the system must define a setback schedule, which is defined by two parameters: T_{off} is the time at which the HVAC system is scheduled to relax the setpoint temperature, and Tₒₙ is the time at which it is scheduled to resume the normal setpoint temperature.

Most modern programmable thermostats provide four programmable parameters (to create setback periods at night), but in this embodiment only two parameters will be used to show the novelty of the algorithm used in the invention. It is important to note, that the algorithm is not limited to two parameters, in fact the more parameters that are used, the more efficient the setback schedule will be. Besides leave and arrival times, additional parameters may include, but are not limited to, when a user bathes, eats, sleeps, or vacations.

Let conditioned time (CT) be the time duration [Tₒₙ,T_{off}] in which the home must be conditioned, and unconditioned time (UCT) be the time duration [T_{off},Tₒₙ], which is equal to 24-CT. Due to the unpredictable nature of home occupancy, an occupant may be home during the unconditioned time. In other words, there may be a time period where T_{off}<Tₗₑₐᵥₑ<Tₒₙ and/or T_{off}<Tₐᵣᵣᵢᵥₑ<Tₒₙ, which is described as miss time. In the preferred embodiment, the measure of the comfort for a schedule, the average miss time (MT), is defined as:

$$MT = {\sum }_{1}^{n} \frac{max ( 0 , {T}_{leave} - {T}_{off} ) + max ( 0 , {T}_{on} - {T}_{arrive} )}{n}$$

In this embodiment, the efficiency of a schedule is evaluated by comparing to a baseline schedule T*_{off}=8:00 and T*ₒₙ=18:00 (or other designated time(s) as desired or required). These times are the default schedule that is required to be preprogrammed onto all Energy Star compliant programmable thermostats. The efficiency of a schedule is defined as the reduction in conditioned time (RCT) over the baseline schedule, which is defined to be:

$$RCT = \frac{24 - ( {T}_{on} - {T}_{off} )}{10}$$

The baseline Energy Star schedule is an aggressive schedule that assumes the home is unoccupied for approximately 10 hours each day. This is a conservative baseline: if the setback schedule is modified at all, the user is likely to reduce the setback period from the default rather than increase it, thereby improving the relative performance of our system.

In an embodiment, the self-programming thermostat defines two optimization algorithms. The first algorithm is called Maximize UCT and it maximizes UCT given MT. The second algorithm is called Minimize MT, and it minimizes MT given UCT.

The values A, B, C, and D represent the minimum and maximum leave and arrival times of an individual:

A=min(Tleave)

B=max(Tleave)

C=min(Tarrive)

D=max(Tarrive)

The algorithm for Maximize UCT is illustrated in Algorithm 1. This algorithm starts with the maximum possible setback period UCT and uses a sliding window technique to calculate the minimum value of MT for all schedules with that setback period. The algorithm gradually shrinks the size of the setback period and repeats until the desired value of MT is achieved. The algorithm returns the first schedule that achieved the desired value of MT.

### Algorithm 1: Maximize UCT

Input: miss time mt, occupancy pattern op

1. for UCT (T_{off},Tₒₙ) =UCT (A,D)+mt to mt
2. Label A′ with UCT (A, A′) = mt. Label D′ with UCT (D, D′) = mt;
3. Slide (T_{off},Tₒₙ) from A′ to D′
4. if MT((T_{off},Tₒₙ),op) = = mt
5. return (T_{off},Tₒₙ) and UCT(T_{off},Tₒₙ);
6. end
7. end
8. end

The algorithm for Minimize MT is illustrated in Algorithm 2. Given a desired value of UCT, this algorithm performs a single pass across the data set by increasing T_{off} from 0 to 24-UCT, setting Tₒₙ=T_{off}+UCT, and calculating the average value of MT. The algorithm then returns the values of T_{off} and Tₒₙ that achieve the minimum average value of MT.

### Algorithm 2: Minimize MT

Input: unconditioned time uct, occupancy pattern op

| | |
|---|---|
| 1. | Fix UCT(T_{off}, Tₒₙ) = uct; |
| 2. | Slide (T_{off}, Tₒₙ) within one day time |
| 3. | [(T_{off},Tₒₙ), MT(T_{off},Tₒₙ), op)] |
| | →{[(T′_{off},T′ₒₙ), mt′]} |
| 4. | return [(T_{off},Tₒₙ), mt] with mt = = min(mt′); |

It should be appreciated that other optimization type algorithms may be implemented or employed within the context of the invention.

It should be appreciated that upon an abrupt occupant change (or behavior) that the current learned schedule may become inefficient due to these changed circumstances (behavior) causing a temporary inefficiency due to the lag time for the system to relearn the new occupancy pattern. It should be appreciated that an occupant (user) can rectify this inefficiency by initiating a new (revised) schedule to minimize the lag time that the system would otherwise require to relearn these new (changed) occupancy patterns. Furthermore, the system can automatically recognize changes in occupancy patterns and initiate a new set of suggestions to the user based on these changes.

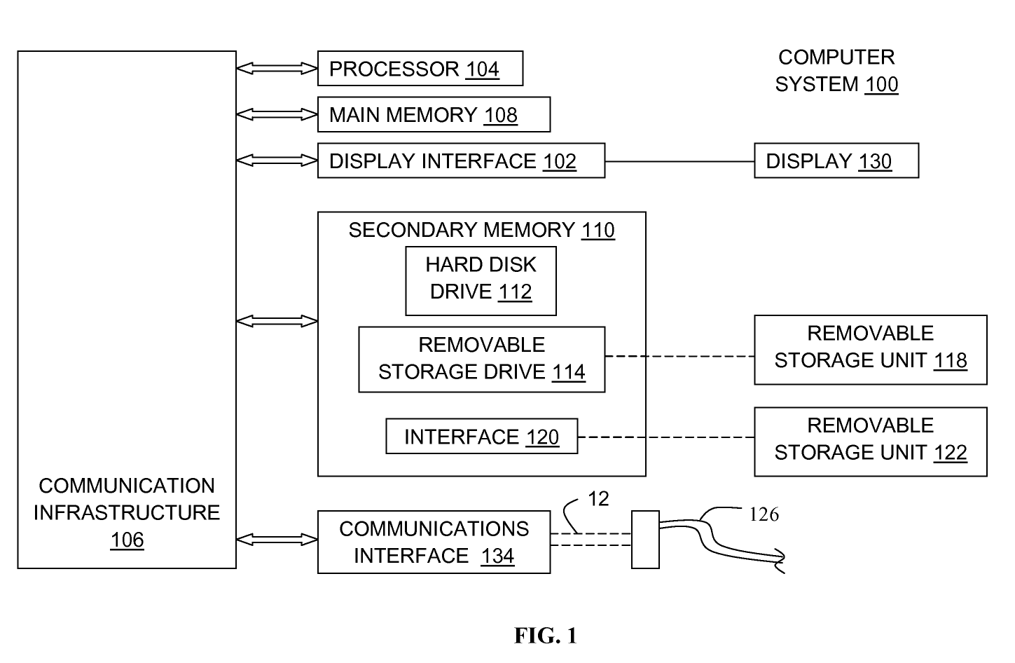

Next, turning to FIG. 1, FIG. 1 is a functional block diagram for a computer system 100 for implementation of an exemplary embodiment or portion of an embodiment of present invention. For example, a method or system of an embodiment of the present invention may be implemented using hardware, software or a combination thereof and may be implemented in one or more computer systems or other processing systems, such as personal digit assistants (PDAs) equipped with adequate memory and processing capabilities. In an example embodiment, the invention was implemented in software running on a general purpose computer 100 as illustrated in FIG. 1. The computer system 100 may includes one or more processors, such as processor 104. The Processor 104 is connected to a communication infrastructure 106 (e.g., a communications bus, cross-over bar, or network). The computer system 100 may include a display interface 102 that forwards graphics, text, and/or other data from the communication infrastructure 106 (or from a frame buffer not shown) for display on the display unit 130. Display unit 130 may be digital and/or analog.

The computer system 100 may also include a main memory 108, preferably random access memory (RAM), and may also include a secondary memory 110. The secondary memory 110 may include, for example, a hard disk drive 112 and/or a removable storage drive 114, representing a floppy disk drive, a magnetic tape drive, an optical disk drive, a flash memory, etc. The removable storage drive 114 reads from and/or writes to a removable storage unit 118 in a well known manner. Removable storage unit 118, represents a floppy disk, magnetic tape, optical disk, etc. which is read by and written to by removable storage drive 114. As will be appreciated, the removable storage unit 118 includes a computer usable storage medium having stored therein computer software and/or data.

In alternative embodiments, secondary memory 110 may include other means for allowing computer programs or other instructions to be loaded into computer system 100. Such means may include, for example, a removable storage unit 122 and an interface 120. Examples of such removable storage units/interfaces include a program cartridge and cartridge interface (such as that found in video game devices), a removable memory chip (such as a ROM, PROM, EPROM or EEPROM) and associated socket, and other removable storage units 122 and interfaces 120 which allow software and data to be transferred from the removable storage unit 122 to computer system 100.

The computer system 100 may also include a communications interface 124. Communications interface 124 allows software and data to be transferred between computer system 100 and external devices. Examples of communications interface 124 may include a modem, a network interface (such as an Ethernet card), a communications port (e.g., serial or parallel, etc.), a PCMCIA slot and card, a modem, etc. Software and data transferred via communications interface 124 are in the form of signals 128 which may be electronic, electromagnetic, optical or other signals capable of being received by communications interface 124. Signals 128 are provided to communications interface 124 via a communications path (i.e., channel) 126. Channel 126 (or any other communication means or channel disclosed herein) carries signals 128 and may be implemented using wire or cable, fiber optics, blue tooth, a phone line, a cellular phone link, an RF link, an infrared link, wireless link or connection and other communications channels.

In this document, the terms “computer program medium” and “computer usable medium” are used to generally refer to media or medium such as various software, firmware, disks, drives, removable storage drive 114, a hard disk installed in hard disk drive 112, and signals 128. These computer program products (“computer program medium” and “computer usable medium”) are means for providing software to computer system 100. The computer program product may comprise a computer useable medium having computer program logic thereon. The invention includes such computer program products. The “computer program product” and “computer useable medium” may be any computer readable medium having computer logic thereon.

Computer programs (also called computer control logic or computer program logic) are may be stored in main memory 108 and/or secondary memory 110. Computer programs may also be received via communications interface 124. Such computer programs, when executed, enable computer system 100 to perform the features of the present invention as discussed herein. In particular, the computer programs, when executed, enable processor 104 to perform the functions of the present invention. Accordingly, such computer programs represent controllers of computer system 100.

In an embodiment where the invention is implemented using software, the software may be stored in a computer program product and loaded into computer system 100 using removable storage drive 114, hard drive 112 or communications interface 124. The control logic (software or computer program logic), when executed by the processor 104, causes the processor 104 to perform the functions of the invention as described herein.

In another embodiment, the invention is implemented primarily in hardware using, for example, hardware components such as application specific integrated circuits (ASICs). Implementation of the hardware state machine to perform the functions described herein will be apparent to persons skilled in the relevant art(s).

In yet another embodiment, the invention is implemented using a combination of both hardware and software.

In an example software embodiment of the invention, the methods described above may be implemented in SPSS control language or C++ programming language, but could be implemented in other various programs, computer simulation and computer-aided design, computer simulation environment, MATLAB, or any other software platform or program, windows interface or operating system (or other operating system) or other programs known or available to those skilled in the art.

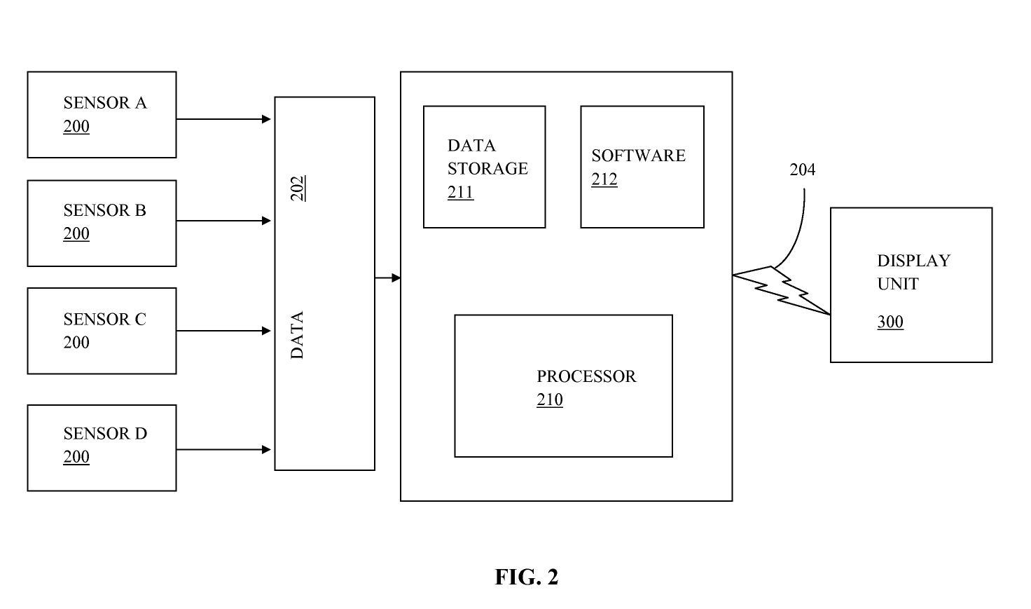

FIG. 2, depicts a high-level schematic diagram of an aspect of embodiment of the present invention. Sensors 200 provide data input 202, such as temperature, humidity, occupancy, energy use, and other data, to the processor 210, where the data is stored by the data storage unit 211, which can be either contained within the processor 210 and/or remotely. The data is then processed by the processor 210 using the software 212 and transmitted via a communication means 204 (or channel) either wirelessly or hard wired (or combination thereof) to the display unit 300. It should be appreciated that a communication means or channel may be implemented between any of the modules (components) displayed in FIG. 2, as well as modules (or components) discussed throughout this disclosure.

It should be appreciated that any of the components or modules referred to for the present invention embodiments as discussed in FIG. 2 (as well as embodiments throughout this disclosure, including the references incorporated by reference herein), may be integrally or separately formed with one another and implemented accordingly for the practicing the invention. Further, redundant functions or structures of the components or modules may be implemented. Moreover, the various components may be communicated locally and/or remotely with any user/occupant/system/computer/processor. Moreover, the various components may be in communication via wireless and/or hardwire or other desirable and available communication means, systems and hardware.

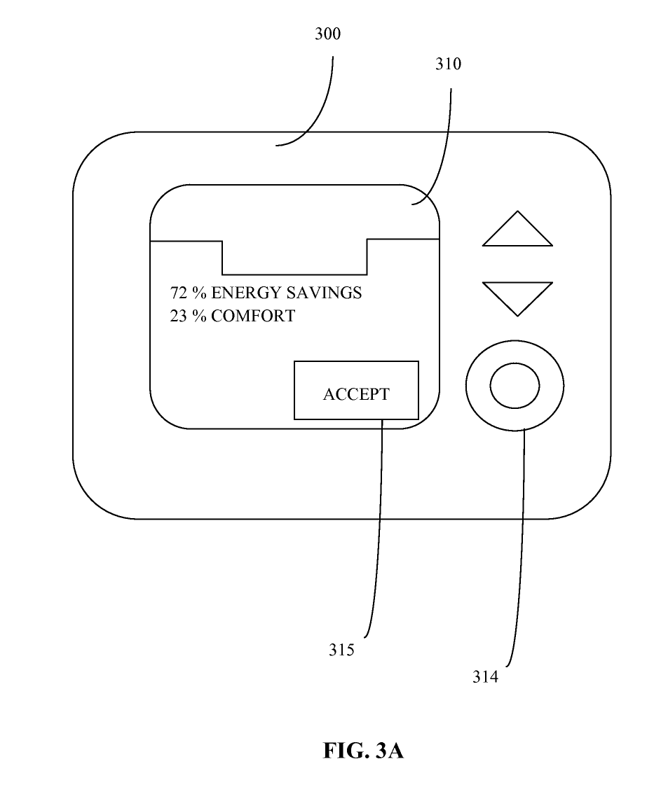

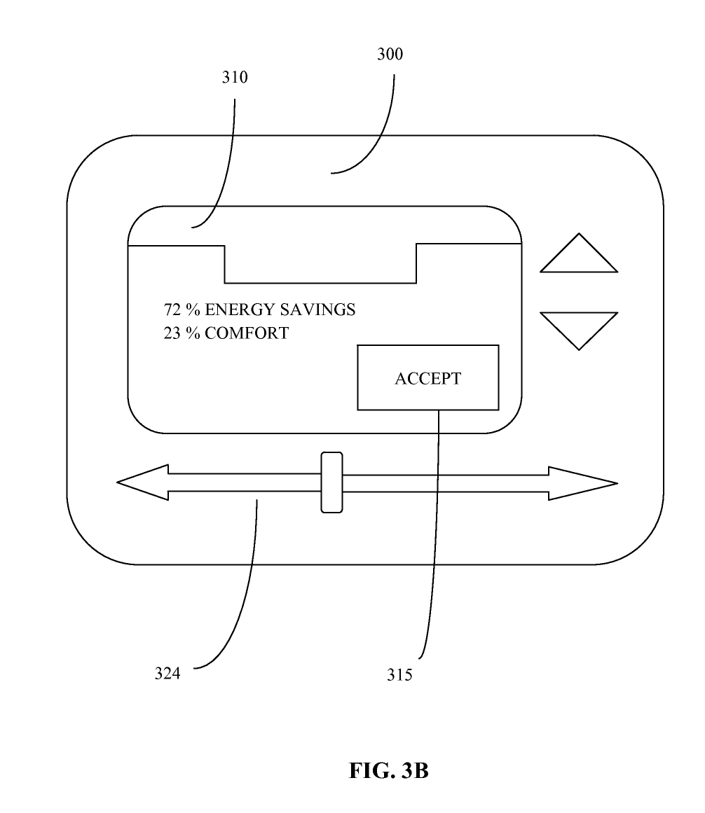

FIGS. 3A and 3B show schematic diagrams of the display unit 300 in two illustrative, non-limiting, embodiments of the invention. Display screen 310 displays each optimal setback schedule for the user, with the temperature settings and the times when they will occur, along with information about the increase or reduction in comfort level (e.g., due to non-missed or missed time) and efficiency, respectively. A decrease in comfort is attributed to an increase in miss time. Referring to the figure, 72% energy savings and 23% comfort level is shown, although it should be appreciated that any desired or required level may be implemented. The user can scroll between each optimal setback schedule using the miss time knob 314 or the miss time slidebar 324. Once the user has chosen an optimal setback schedule, the user may select the schedule using the accept button 315. Other icons, buttons, switches or keys may be included as well as desired or required. In addition to visual displays, audible or tactile communication may be implemented also.

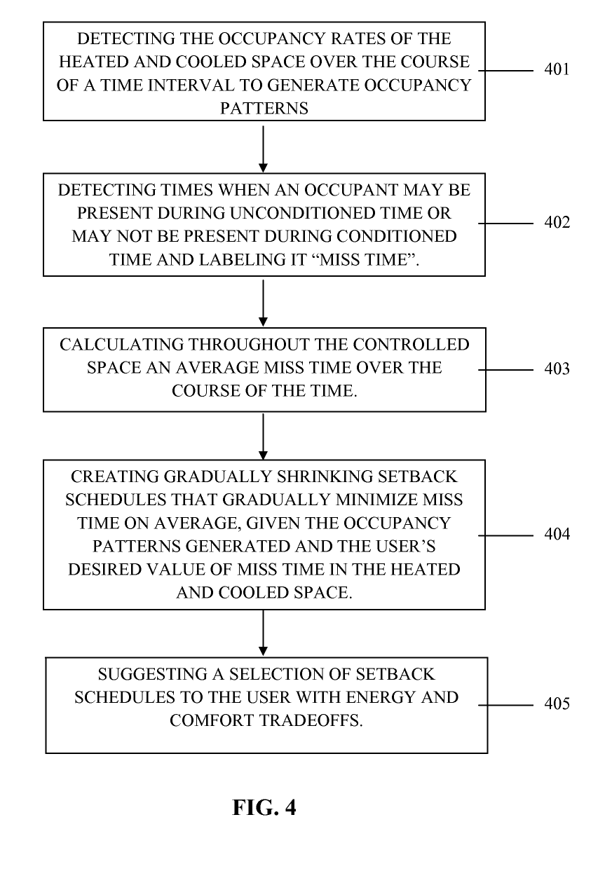

FIG. 4 depicts the illustrative steps of the method (or corresponding software/hardware/firmware modules) for an aspect of an embodiment of the present invention. In the first step 401, the method must detect the occupancy rates of the heated and cooled space over the course of a time interval to generate occupancy patterns. Then, miss time is calculated 402 by detecting times when an occupant may be present during unconditioned time or may not be present during conditioned time. The miss time throughout the controlled space is determined, in order to generate an average miss time 403 over the course of the time. The average miss time is then minimized 404 by creating gradually shrinking setback schedules, given the occupancy patterns generated and the user's desired value of miss time in the heated and cooled space. Finally, the generated selection of optimal setback schedules is suggested to the user with energy and comfort tradeoffs 405.

The devices, systems, components, modules, computer program products, means, structures, and methods of various embodiments of the invention disclosed herein may utilize aspects disclosed in the following references, applications, publications and patents and which are hereby incorporated by reference herein in their entirety:
1. Ge Gao and Kamin Whitehouse. “The Self-Programming Thermostat: Optimizing Setback Schedules based on Home Occupancy Patterns”. First ACM Workshop On Embedded Sensing Systems For Energy-Efficiency In Buildings (BuildSys '09), held in conjunction with ACM SenSys. Berkeley, Calif., November 2009. (PPT) http://www.cs.virginia.edu/˜whitehouse/pubs.html
2. U.S. PG Publication No. 2003/0040842, Poth, R., “Usage Monitoring HVAC Control System”, Feb. 27, 2003.
3. U.S. PG Publication No. 2004/0133314, Ehlers et al., “System and Method of Controlling an HVAC System,” Jul. 8, 2004.
4. U.S. PG Publication No. 2007/0045431, Chapman, Jr. et al., “Occupancy-based Zoning Climate Control System and Method,” Mar. 1, 2007.
5. U.S. PG Publication No. 2008/0191045, Harter, R., “Self-Programmable Thermostat,” Aug. 14, 2008.
6. U.S. PG Publication No. 2010/0019051, Rosen, H., “Override of Nonoccupancy Status in a Thermostat Device Based Upon Analysis of Recent Patterns of Occupancy,” Jan. 28, 2010.
7. U.S. PG Publication No. 2010/0025483, Hoeynck et al., “Sensor-based Occupancy and Behavior Prediction Method for Intelligently Controlling Energy Consumption Within a Building,” Feb. 4, 2010.
8. U.S. PG Publication No. 2010/0289643, Trundle et al., “Remote Device Control and Energy Monitoring,” Nov. 18, 2010.
9. U.S. Pat. No. 5,814,902, Creasy et al., “System and Process for Control of Energy Use by Direct Observation of Occupancy,” Sep. 29, 1998.
10. U.S. Pat. No. 5,819,840, Wilson et al., “Thermostat with Occupancy Detector,” Oct. 13, 1998.
11. Jiakang Lu, Tamim Sookoor, Vijay Srinivasan, Gao Ge, Brian Holben, John Stankovic, Eric Field, Kamin Whitehouse, “The Smart Thermostat: Using Occupancy Sensors to Save Energy in Homes”. The 8^{th} ACM Conference on Embedded Networked Sensing Systems (SenSys), Nov. 3-5, 2010, Zurich, Switzerland.
12. Vijay Srinivasan, John Stankovic and Kamin Whitehouse, “Using Height Sensors for Biometric Identification in Multi-resident Homes”, in Proceedings of the 8^{th} International Conference on Pervasive Computing (Pervasive). Helsinki, Finland, May 17-20, 2010.
13. U.S. Pat. No. 5,476,221, Seymour, R., “Easy-To-Install Thermostatic Control System Based on Room Occupancy”, Dec. 19, 1995.
14. U.S. Pat. No. 7,918,406 B2, Rosen, H., “Override of Nonoccupancy Status in a Thermostat Device Based Upon Analysis of Recent Patterns of Occupancy”, Apr. 5, 2011.
15. U.S. Pat. No. 7,784,704 B2, Harter, R., “Self-Programmable Thermostat”, Aug. 31, 2010.
16. U.S. Patent Application Publication No. 2004/0262410 A1, Hull, G., “Graphical Thermostat and Sensor”, Dec. 30, 2004.
17. U.S. Patent Application Publication No. 2008/0277486 A1, Seem, et al., “HVAC Control System and Method”, Nov. 13, 2008.
18. U.S. Patent Application Publication No. 2010/0025483 A1, Hoeynck, et al., Feb. 4, 2010.
19. U.S. Pat. No. 5,088,645, Bell, I., “Self-Programmable Temperature Control System for a Heating and Cooling System”, Feb. 18, 1992.
20. U.S. Pat. No. 5,115,967, Wedekind, G., “Method and Apparatus for Adaptively Optimizing Climate Control Energy Consumption in a Building”, May 26, 1992.
21. U.S. Pat. No. 5,165,465, Kenet, R., “Room Control System”, Nov. 24, 1992.
22. U.S. Pat. No. 5,170,935, Federspiel, et al., “Adaptable Control of HVAC Systems”, Dec. 15, 1992.
23. U.S. Pat. No. 5,261,481, Baldwin, et al., “Method of Determining Setback for HVAC System”, Nov. 16, 1993.
24. U.S. Pat. No. 6,216,956 B1, Ehlers, et al., “Environmental Condition Control and Energy Management System and Method”, Apr. 17, 2001.
25. U.S. Pat. No. 6,741,915 B2, Poth, R., “Usage Monitoring HVAC Control System”, May 25, 2004.
26. U.S. Pat. No. 7,253,732 B2, “Osann, Jr., R., “Home Intrusion Confrontation Avoidance System”, Aug. 7, 2007.
27. U.S. Pat. No. 7,274,975 B2, Miller, C., “Optimized Energy Management System”, Sep. 25, 2007.
28. U.S. Pat. No. 7,861,941 B2, Schultz, et al., “Automatic Thermostat Schedule/Program Selector System”, Jan. 4, 2011.
29. U.S. Pat. No. 6,351,693 B1, Monie, et al., “Computerized System for Controlling Thermostats”, Feb. 26, 2002.
30. U.S. Pat. No. 7,469,550 B2, Chapman, Jr., et al., “System and Method for Controlling Appliances and Thermostat for Use Therewith”, Dec. 30, 2008.
31. Ben Shneiderman, “Direct Manipulation for Comprehensible, Predictable and Controllable User Interfaces”, IUI 97, Proceedings of the 2^{nd} International Conference on Intelligent User Interfaces”, ACM, New York, N.Y. 1997, pgs. 33-39.

### EXAMPLES

Practice of an aspect of an embodiment (or embodiments) of the invention will be still more fully understood from the following examples, which are presented herein for illustration only and should not be construed as limiting the invention in any way.

Example 1 includes a self-programming thermostat control system that automatically senses, creates and suggests highly energy efficient and optimized setback schedules for controlling energy consumption within a space in a controllable and predictable manner for a user in accordance with consistently changing historical occupancy patterns of a space, said system comprises:

a. detecting means for detecting said occupancy rates;

b. timing means for capturing said time interval data;

c. frequency means for determining the rate and consistency at which these detecting means detect varying occupancy rates at these different time intervals that correspond with different user-based activity functions;

d. storage means for aggregating historical occupancy rates generated by the detecting means in conjunction with the timing and frequency means;

e. programming means for reading, analyzing, and modeling the collected historical occupancy rates from the detecting means at changing times and frequencies using the timing and frequency means to derive occupancy pattern models that are used to generate and suggest a selection of efficient setback schedules that can be optimized by the user for greater energy efficiency and comfort in a space; and

f. display means that display a selection of optimal setback schedules generated by using the detecting, timing, frequency, and programming means of the system; that displays information to the user that balances energy usage and comfort; and that contains a selection means which allows a user to choose from the selection of optimal setback schedules for use in the space.

Example 2 may optionally include the system of example 1, wherein said space is a heated and/or cooled space or space that can be heated and/or cooled in the future such as a home, building, dwelling, aircraft, watercraft, train, or automobile.

Example 3 may optionally include the system of example 1 (as well as subject matter of one or more of any combination of examples 1-2), wherein said user comprises of an occupant or official that manages the space from within or from an external location.

Example 4 may optionally include the system of example 1 (as well as subject matter of one or more of any combination of examples 1-3), further comprising of communicating means that enable the self-programming thermostat control system to be implemented using hardware, software, or a combination thereof to allow for simple control by the user.

Example 5 may optionally include the system of example 4 (as well as subject matter of one or more of any combination of examples 1-4), wherein said communicating means is configured to allow for remote control access by the user through main frame, PDA, smart phone, personal computer, lap-top, mobile phone, short message service (SMS), or via email.

Example 6 may optionally include the system of example 5 (as well as subject matter of one or more of any combination of examples 1-4), wherein said communicating means is configured to allow for automatic syncing of user's personal schedules and appointments available online through an electronic calendar to supplement the occupancy data logged by the detecting means of the system to better generate occupancy patterns within the space.

Example 7 may optionally include the system of example 1 (as well as subject matter of one or more of any combination of examples 1-6), wherein said detecting means are one or more detecting means selected from the group consisting of motion detecting means, door opening means, garage opening means, sound detecting means, light detecting means, electric voltage use means, and water usage means.

Example 8 may optionally include the system of example 1 (as well as subject matter of one or more of any combination of examples 1-7), wherein said detecting means are used to detect subtle and abrupt changes in occupancy in the space.

Example 9 may optionally include the system of example 1 (as well as subject matter of one or more of any combination of examples 1-8), wherein said detecting means are placed throughout different areas of the space.

Example 10 may optionally include the system of example 1 (as well as subject matter of one or more of any combination of examples 1-9), wherein said detecting means include the use of sensors.

Example 11 may optionally include the system of example 1 (as well as subject matter of one or more of any combination of examples 1-10), wherein said motion detecting means is selected from the group consisting of infrared heat sensors, infrared motion sensors, and ultrasonic sensors.

Example 12 may optionally include the system of example 1 (as well as subject matter of one or more of any combination of examples 1-11), wherein said activity functions are one or more activity functions comprising of sleeping, eating, bathing, arriving, working, and exercising.

Example 13 may optionally include the system of example 1 (as well as subject matter of one or more of any combination of examples 1-12), wherein said timing means comprises a digital clock and calendar to time stamp and collect data for changes in occupancy detected by the detecting means.

Example 14 may optionally include the system of example 1 (as well as subject matter of one or more of any combination of examples 1-13), wherein said time intervals comprises of minute by minute logging of data associated with changes in occupancy rates.

Example 15 may optionally include the system of example 1 (as well as subject matter of one or more of any combination of examples 1-14), wherein said rate and consistency at which these detecting means sense varying occupancy rates at these different times is turned into an occupancy record.

Example 16 may optionally include the system of example 15 (as well as subject matter of one or more of any combination of examples 1-14), wherein said occupancy record includes occupancy rates for about at least the previous about two weeks. Although, the duration may be less than two weeks as well. In general, some examples may include, one or more months, about 3 or 4 weeks, about 2 or 3 weeks, about 1 or 2 weeks, about 1 week, or less than about 1 week.

Example 17 may optionally include the system of example 1 (as well as subject matter of one or more of any combination of examples 1-15), wherein the programming means of the thermostat analyzes aggregated and stored occupancy records and converts them into occupancy pattern models to be optimized for the production of at least two of said suggested efficient setback schedules for the user.

Example 18 may optionally include the system of example 17 (as well as subject matter of one or more of any combination of examples 1-16), wherein said at least two suggested efficient setback schedules are produced by minimizing desired miss time on average by the user, given occupancy statistics over a time period.

Example 19 may optionally include the system of example 18 (as well as subject matter of one or more of any combination of examples 1-17), wherein said miss time is time where the space is conditioned or unconditioned when it should not be, causing discomfort and waste to the user.

Example 20 may optionally include the system of example 17 (as well as subject matter of one or more of any combination of examples 1-16), wherein said at least two suggested efficient setback schedules are generated along a Pareto optimal time curve.

Example 21 may optionally include the system of example 1 (as well as subject matter of one or more of any combination of examples 1-20), wherein the display means comprises of selection means that allows the user to toggle between said at least two suggested efficient setback schedules and view the tradeoffs between energy and comfort for each suggested setback schedule.

Example 22 may optionally include the system of example 21 (as well as subject matter of one or more of any combination of examples 1-20), wherein said selection means is a knob.

Example 23 may optionally include the system of example 21 (as well as subject matter of one or more of any combination of examples 1-22), wherein said selection means is a slidebar.

Example 24 may optionally include the system of example 21 (as well as subject matter of one or more of any combination of examples 1-23), wherein said selection means allow any user to dial into any point on said Pareto Optimal Curve to see said tradeoffs between energy and comfort for different schedules.

Example 25 may optionally include the system of example 1 (as well as subject matter of one or more of any combination of examples 1-24), wherein the display interface can be digital or analog.

Example 26 may optionally include the system of example 1 (as well as subject matter of one or more of any combination of examples 1-25), wherein the storage means is integral with at least one of said thermostat, a server, or other remote-access storage device that can easily interact with said self-programming thermostat system through its communicating means.

Example 27 may include a method for a self-programming thermostat that automatically creates optimal setback schedules by detecting varying occupancy statistics of a space to achieve greater energy efficiency and comfort for an occupant, the method comprising:

a. selecting an initial baseline setback schedule that is defined by occupant;

b. detecting the occupancy rates of the heated and/or cooled space throughout the cooled and/or heated space over the course of a time interval to generate occupancy patterns, which is defined by activity parameters;

c. consistently detecting and logging variance in said occupancy rates by the occupant at the said defined activity parameters and labeling it miss time;

d. using said miss time to calculate an average miss time over the course of said time interval;

e. creating gradually shrinking setback schedules that gradually minimize said miss time; and

f. suggesting a selection of at least two setback schedules with the least said average miss time to the user in an easy to use display model interface with different energy and comfort tradeoffs shown.

Example 28 may optionally include the method of example 27, further comprising of communicating the suggested selection of setback schedules through servers or other processor to allow for remote control by the user.

Example 29 may optionally include the method of example 28 (as well as subject matter of example 27), wherein said occupant maybe the user located within the heated and/or cooled space or an external user such as a building manager or a distant user away from the space for a period of time.

Example 30 may optionally include the method of example 27 (as well as subject matter of one or more of any combination of examples 27-29), wherein heated and/or cooled space comprises at least one of: building, dwelling, house, vehicle, aircraft, spacecraft, ship, or any other space that may be heated and/or cooled.

Example 31 may optionally include the method of example 27 (as well as subject matter of one or more of any combination of examples 27-30), wherein said initial baseline schedule may be an EnergyStar schedule that automatically turns off the HVAC system at a first designated time and turns it on at a second designated time for the user.

Example 32 may optionally include the method of example 27 (as well as subject matter of one or more of any combination of examples 27-31), wherein said initial baseline schedule may be a schedule previously produced by the self-programming thermostat.

Example 33 may optionally include the method of example 27 (as well as subject matter of one or more of any combination of examples 27-32), wherein said activity parameters comprise of activities such as when the occupant leaves, arrives, sleeps, eats, or bathes in the heated and/or cooled space.

Example 34 may optionally include the method of example 27 (as well as subject matter of one or more of any combination of examples 27-33), wherein detected occupancy rates are gathered through detecting changes in occupancy in the heated and/or cooled space.

Example 35 may optionally include the method of example 27 (as well as subject matter of one or more of any combination of examples 27-34), wherein said detecting is provided through the use of sensors.

Example 36 may optionally include the method of example 35 (as well as subject matter of one or more of any combination of examples 27-35), wherein said sensors is selected from the group consisting of infrared heat sensors, infrared motion sensors, and ultrasonic sensors.

Example 37 may optionally include the method of example 27 (as well as subject matter of one or more of any combination of examples 27-36), wherein said variance comprises of capturing consistently changing occupancy rate data of the occupant over a time interval and storing these changed miss times to better reflect changing occupancy patterns by the occupant at said defined activity parameters.

Example 38 may optionally include the method of example 27 (as well as subject matter of one or more of any combination of examples 27-37), wherein said miss time is the time when an occupant may be present during unconditioned time of the space or may not be present during conditioned time of the space.

Example 39 may optionally include the method of example 27 (as well as subject matter of one or more of any combination of examples 27-38), wherein said miss time is collected and logged through the use of a digital clock and calendar within the thermostat to time stamp when said miss time occurs.

Example 40 may optionally include the method of example 27 (as well as subject matter of one or more of any combination of examples 27-39), wherein said time intervals comprises of minute by minute logging of data associated with changes in occupancy rates.

Example 41 The method of example 40 (as well as subject matter of one or more of any combination of examples 27-39), wherein said time intervals can be optimized by user for longer or shorter time intervals.

Example 42 may optionally include the method of example 27 (as well as subject matter of one or more of any combination of examples 27-41), wherein said occupancy rates is configured to provide an occupancy record.

Example 43 may optionally include the method of example 42 (as well as subject matter of one or more of any combination of examples 27-41), wherein said occupancy records include occupancy rates for about at least the previous two weeks. Although, the duration may be less than two weeks as well. In general, some examples may include, one or more months, about 3 or 4 weeks, about 2 or 3 weeks, about 1 or 2 weeks, about 1 week, or less than about 1 week.

Example 44 may optionally include the method of example 27 (as well as subject matter of one or more of any combination of examples 27-43), further comprising converting said occupancy rates into occupancy pattern models to be optimized for the production of said selection of suggested efficient setback schedules for the occupant.

Example 45 may optionally include the method of example 27 (as well as subject matter of one or more of any combination of examples 27-44), wherein said average miss time is defined as a proxy for occupant comfort.

Example 46 may optionally include the method of example 27 (as well as subject matter of one or more of any combination of examples 27-45), wherein said gradually shrinking setback schedules that gradually minimize miss time on average are generated through the use of two optimization algorithms.

Example 47 may optionally include the method of example 46 (as well as subject matter of one or more of any combination of examples 27-45), wherein said two optimization algorithms include: a maximization of Unconditioned Time (UCT) algorithm given user's desired miss time selection and a minimization of average miss time algorithm.

Example 48 may optionally include the method of example 47 (as well as subject matter of one or more of any combination of examples 27-46), wherein said maximization of unconditioned time algorithm starts with the maximum possible setback period and uses a sliding window technique to calculate the minimum value of miss time for all schedules with that setback period.

Example 49 may optionally include the method of example 48 (as well as subject matter of one or more of any combination of examples 27-47), wherein the maximization of unconditioned time algorithm is applied to all values of desired miss time from about 0 to about 24 hours at fifteen minute intervals and produces a Pareto Optimal curve of setback schedules that maps the longest duration setback period for every possible miss time.

Example 50 may optionally include the method of example 48 (as well as subject matter of one or more of any combination of examples 27-47), wherein said sliding window technique gradually shrinks the size of the setback period and repeats until the desired value of miss time by the user is achieved.

Example 51 may optionally include method of example 50 (as well as subject matter of one or more of any combination of examples 27-49), wherein said desired value of miss time is controlled by selection means that allow a user to toggle between at least two suggested efficient setback schedules on said Pareto Optimal Curve and view the tradeoffs between energy and comfort for each suggested setback schedule.

Example 52 may optionally include the method of example 51 (as well as subject matter of one or more of any combination of examples 27-50), wherein selection means may include a miss time knob which allows each user to dial into any point on said Pareto optimal curve.

Example 53 may optionally include the method of example 47 (as well as subject matter of one or more of any combination of examples 27-52), wherein said maximization of unconditioned time algorithm produces a schedule that achieves said user's desired value of miss time.

Example 54 may optionally include the method of example 47 (as well as subject matter of one or more of any combination of examples 27-53), wherein said minimization of average miss time algorithm starts with the schedule produced by the first algorithm and further optimizes it by scanning across the entire accumulated occupancy data set that includes said user variance and generates a schedule that achieves the minimum average value of miss time given the desired miss time selected by user.

Example 55 may optionally include the method of example 54 (as well as subject matter of one or more of any combination of examples 27-53), wherein said algorithm optimizes setback schedules to achieve an average miss time aligned with the desired miss time selected by user.

Example 56 includes a self-programming thermostat control system (as well as subject matter of one or more of any combination of examples 1-26) that automatically creates and suggests highly energy efficient and optimized setback schedules for controlling energy consumption within a space in a controllable and predictable manner intended for a user accordance with consistently changing historical occupancy patterns of a heated and/or cooled space, wherein said system is configured to receive a) occupancy rates associated with different activity functions within the desired heated and/or cooled space and b) captured time intervals when the change of occupancy occurs in the heated and/or cooled space, and wherein said system further comprises:

a. frequency means for determining the rate and consistency of the received occupancy rates at the captured time intervals that correspond with different user-based activity functions;

b. storage means for aggregating historical occupancy rates generated by the detecting means in conjunction with the timing and frequency means;

c. programming means for reading, analyzing, and modeling the collected historical occupancy rates from the detecting means at changing times and frequencies using the timing and frequency means to derive occupancy pattern models that are used to generate and suggest a selection of efficient setback schedules that can be optimized by the user for greater energy efficiency and comfort in a space; and

d. display means that display a selection of optimal setback schedules generated by using the detecting, timing, frequency, and programming means of the system; that displays information to the user that balances energy usage and comfort; and that contains a selection means which allows a user to choose from the selection of optimal setback schedules for use in the space.

Example 57 may optionally include the system of example 56 (as well as subject matter of one or more of any combination of examples 1-26), wherein the programming means of the thermostat analyzes aggregated and stored occupancy rates and converts them into occupancy pattern models to be optimized for the production of at least two of said suggested efficient setback schedules for the user.

Example 58 may optionally include the system of example 57 (as well as subject matter of one or more of any combination of examples 1-26), wherein said at least two suggested efficient setback schedules are produced by minimizing desired miss time on average by the user, given occupancy statistics over a time period.

Example 59 may optionally include the system of example 56 (as well as subject matter of one or more of any combination of examples 1-26), wherein the display means comprises of selection means that allows the user to toggle between said at least two suggested efficient setback schedules and view the tradeoffs between energy and comfort for each suggested setback schedule.

Example 60 may include a computer program product comprising a non-transitory computer useable medium having a computer program logic for enabling at least one processor in a computer system to automatically create optimal setback schedules to achieve greater energy efficiency and comfort for an occupant, said computer program logic comprising:

a. receiving a selected initial baseline setback schedule;

b. receiving detected occupancy rates of the heated and/or cooled space throughout the cooled and/or heated space over the course of a time interval to generate occupancy patterns, which is defined by activity parameters;

c. receiving detected and logged variance in said occupancy rates by the occupant at the said defined activity parameters and labeling it miss time;

d. using said miss time to calculate an average miss time over the course of said time interval;

e. creating gradually shrinking setback schedules that gradually minimize miss time; and

f. suggesting a selection of at least two setback schedules with the least said average miss time to the user in an easy to use display model interface with different energy and comfort tradeoffs shown.

Example 61 may optionally include the computer program product of example 60 (as well as subject matter of one or more of any combination of examples 27-55), wherein said gradually shrinking setback schedules are generated through the use of two optimization algorithms, which include: a maximization of Unconditioned Time (UCT) algorithm given the user's desired miss time selection and a minimization of average time algorithm.

Example 62 may optionally include the computer program product of example 61 (as well as subject matter of one or more of any combination of examples 27-55), wherein said maximization of unconditioned time algorithm starts with the maximum possible setback period and uses a sliding window technique to calculate the minimum value of miss time for all schedules with that setback period.

Example 63 may optionally include the computer program product of example 62 (as well as subject matter of one or more of any combination of examples 27-55), wherein the maximization of unconditioned time algorithm is applied to all values of desired miss time from about 0 to about 24 hours at about fifteen minute time intervals and produces a Pareto Optimal curve of setback schedules that maps the longest duration setback period for every possible miss time.

Example 64 may include a self-programming thermostat control system that automatically senses, creates and suggests highly energy efficient and optimized setback schedules for controlling energy consumption within a space in a controllable and predictable manner for a user in accordance with consistently changing historical occupancy patterns of a space, said system comprises:

a. a detector, said detector detects occupancy rates;

b. a timer for capturing said time interval data and for determining the rate and consistency at which the detector detects varying occupancy rates at these different time intervals that correspond with different user-based activity functions;

c. storage for aggregating historical occupancy rates generated by the detector in conjunction with corresponding said time intervals;

d. a computer processor for reading, analyzing, and modeling the collected historical occupancy rates from the detector at changing times and frequencies using the timer to derive occupancy pattern models that are used to generate and suggest a selection of efficient setback schedules that can be optimized by the user for greater energy efficiency and comfort in a space; and

e. a display device that displays a selection of optimal setback schedules generated by using the detecting, timing, frequency, and programming means of the system; that displays information to the user that balances energy usage and comfort, and provides a selection mechanism that allows a user to choose from the selection of optimal setback schedules for use in the space.

Example 65 may optionally include the system of example 64 (as well as subject matter of one or more of any combination of examples 1-26), wherein said computer processor analyzes aggregated and stored occupancy rates and converts them into occupancy pattern models to be optimized for the production of at least two of said suggested efficient setback schedules for the user.

Example 66 may optionally include the system of example 65 (as well as subject matter of one or more of any combination of examples 1-26), wherein said at least two suggested efficient setback schedules are produced by minimizing desired miss time on average by the user, given occupancy statistics over a time period.

Example 67 may optionally include the system of example 65 (as well as subject matter of one or more of any combination of examples 1-26), wherein the display comprises of a selection tool that allows the user to toggle between said at least two suggested efficient setback schedules and view the tradeoffs between energy and comfort for each suggested setback schedule.

Example 68 may include a self-programming thermostat control system that automatically creates and suggests highly energy efficient and optimized setback schedules for controlling energy consumption within a space in a controllable and predictable manner intended for a user accordance with consistently changing historical occupancy patterns of a heated and/or cooled space, wherein said system is configured to receive a) occupancy rates associated with different activity functions within the desired heated and/or cooled space and b) captured time intervals when the change of occupancy occurs in the heated and/or cooled space, and wherein said system further comprises:

a. timer for determining the rate and consistency of the received occupancy rates at the captured time intervals that correspond with different user-based activity functions;

b. storage for aggregating historical occupancy rates;

c. processor for reading, analyzing, and modeling the collected historical occupancy rates to derive occupancy pattern models that are used to generate and suggest a selection of efficient setback schedules that can be optimized by the user for greater energy efficiency and comfort in a space; and

d. display unit that displays a selection of optimal setback schedules that displays information to the user that balances energy usage and comfort, and that contains a selection mechanism that allows a user to choose from the selection of optimal setback schedules for use in the space.

Example 69 may include a method of manufacturing said self-programming thermostat control system (e.g., including the various combinations of the related components, modules and devices disclosed) according to any one or more of Examples 1-68.

In summary, while the present invention has been described with respect to specific embodiments, many modifications, variations, alterations, substitutions, and equivalents will be apparent to those skilled in the art. The present invention is not to be limited in scope by the specific embodiment described herein. Indeed, various modifications of the present invention, in addition to those described herein, will be apparent to those of skill in the art from the foregoing description and accompanying drawings. Accordingly, the invention is to be considered as limited only by the spirit and scope of the following claims, including all modifications and equivalents.

Still other embodiments will become readily apparent to those skilled in this art from reading the above-recited detailed description and drawings of certain exemplary embodiments. It should be understood that numerous variations, modifications, and additional embodiments are possible, and accordingly, all such variations, modifications, and embodiments are to be regarded as being within the spirit and scope of this application. For example, regardless of the content of any portion (e.g., title, field, background, summary, abstract, drawing figure, etc.) of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated. Further, any activity or element can be excluded, the sequence of activities can vary, and/or the interrelationship of elements can vary. Unless clearly specified to the contrary, there is no requirement for any particular described or illustrated activity or element, any particular sequence or such activities, any particular size, speed, material, dimension or frequency, or any particularly interrelationship of such elements. Accordingly, the descriptions and drawings are to be regarded as illustrative in nature, and not as restrictive. Moreover, when any number or range is described herein, unless clearly stated otherwise, that number or range is approximate. When any range is described herein, unless clearly stated otherwise, that range includes all values therein and all sub ranges therein. Any information in any material (e.g., a United States/foreign patent, United States/foreign patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such incorporated by reference material is specifically not incorporated by reference herein.

I claim:

1. A self-programming thermostat control system that automatically senses, creates and suggests highly energy efficient and optimized setback schedules for controlling energy consumption within a space in a controllable and predictable manner for a user in accordance with consistently changing historical occupancy patterns of a space, said system comprises:
detecting means for detecting said occupancy rates;
timing means for capturing said time interval data;
frequency means for determining the rate and consistency at which these detecting means detect varying occupancy rates at these different time intervals that correspond with different user-based activity functions;
storage means for aggregating historical occupancy rates generated by the detecting means in conjunction with the timing and frequency means;
programming means for reading, analyzing, and modeling the collected historical occupancy rates from the detecting means at changing times and frequencies using the timing and frequency means to derive occupancy pattern models that are used to generate and suggest a selection of efficient setback schedules that can be optimized by the user for greater energy efficiency and comfort in a space; and
display means that display a selection of optimal setback schedules generated by using the detecting, timing, frequency, and programming means of the system; that displays information to the user that balances energy usage and comfort; and that contains a selection means which allows a user to choose from the selection of optimal setback schedules for use in the space.

2. The system of claim 1, wherein said space is a heated and/or cooled space or space that can be heated and/or cooled in the future such as a home, building, dwelling, aircraft, watercraft, train, or automobile.

3. The system of claim 1, wherein said user comprises of an occupant or official that manages the space from within or from an external location.

4. The system of claim 1, further comprising of communicating means that enable the self-programming thermostat control system to be implemented using hardware, software, or a combination thereof to allow for simple control by the user.

5. The system of claim 4, wherein said communicating means is configured to allow for remote control access by the user through main frame, PDA, smart phone, personal computer, lap-top, mobile phone, short message service (SMS), or via email.

6. The system of claim 5, wherein said communicating means is configured to allow for automatic syncing of user's personal schedules and appointments available online through an electronic calendar to supplement the occupancy data logged by the detecting means of the system to better generate occupancy patterns within the space.

7. The system of claim 1, wherein said detecting means are one or more detecting means selected from the group consisting of motion detecting means, door opening means, garage opening means, sound detecting means, light detecting means, electric voltage use means, and water usage means.

8. The system of claim 1, wherein said detecting means are used to detect subtle and abrupt changes in occupancy in the space.

9. The system of claim 1, wherein said detecting means are placed throughout different areas of the space.

10. The system of claim 1, wherein said detecting means include the use of sensors.

11. The system of claim 1, wherein said motion detecting means is selected from the group consisting of infrared heat sensors, infrared motion sensors, and ultrasonic sensors.

12. The system of claim 1, wherein said activity functions are one or more activity functions comprising of sleeping, eating, bathing, arriving, working, and exercising.

13. The system of claim 1, wherein said timing means comprises a digital clock and calendar to time stamp and collect data for changes in occupancy detected by the detecting means.

14. The system of claim 1, wherein said time intervals comprises of minute by minute logging of data associated with changes in occupancy rates.

15. The system of claim 1, wherein said rate and consistency at which these detecting means sense varying occupancy rates at these different times is turned into an occupancy record.

16. The system of claim 15, wherein said occupancy record includes occupancy rates for about at least the previous two weeks.

17. The system of claim 1, wherein the programming means of the thermostat analyzes aggregated and stored occupancy records and converts them into occupancy pattern models to be optimized for the production of at least two of said suggested efficient setback schedules for the user.

18. The system of claim 17, wherein said at least two suggested efficient setback schedules are produced by minimizing desired miss time on average by the user, given occupancy statistics over a time period.

19. The system of claim 18, wherein said miss time is time where the space is conditioned or unconditioned when it should not be, causing discomfort and waste to the user.

20. The system of claim 17, wherein said at least two suggested efficient setback schedules are generated along a Pareto optimal time curve.

21. The system of claim 1, wherein the display means comprises of selection means that allows the user to toggle between said at least two suggested efficient setback schedules and view the tradeoffs between energy and comfort for each suggested setback schedule.

22. The system of claim 21, wherein said selection means is a knob.

23. The system of claim 21, wherein said selection means is a slidebar.

24. The system of claim 21, wherein said selection means allow any user to dial into any point on said Pareto Optimal Curve to see said tradeoffs between energy and comfort for different schedules.

25. The system of claim 1, wherein the display interface can be digital or analog.

26. The system of claim 1, wherein the storage means is integral with at least one of said thermostat, a server, or other remote-access storage device that can easily interact with said self-programming thermostat system through its communicating means.

27. A method for a self-programming thermostat that automatically creates optimal setback schedules by detecting varying occupancy statistics of a space to achieve greater energy efficiency and comfort for an occupant, the method comprising:
selecting an initial baseline setback schedule that is defined by occupant;
detecting the occupancy rates of the heated and/or cooled space throughout the cooled and/or heated space over the course of a time interval to generate occupancy patterns, which is defined by activity parameters;
consistently detecting and logging variance in said occupancy rates by the occupant at the said defined activity parameters and labeling it miss time;
using said miss time to calculate an average miss time over the course of said time interval;
creating gradually shrinking setback schedules that gradually minimize said miss time; and
suggesting a selection of at least two setback schedules with the least said average miss time to the user in an easy to use display model interface with different energy and comfort tradeoffs shown.

28. The method of claim 27, further comprising of communicating the suggested selection of setback schedules through servers or other processor to allow for remote control by the user.

29. The method of claim 28, wherein said occupant maybe the user located within the heated and/or cooled space or an external user such as a building manager or a distant user away from the space for a period of time.

30. The method of claim 27, wherein heated and/or cooled space comprises at least one of: building, dwelling, house, vehicle, aircraft, spacecraft, ship, or any other space that may be heated and/or cooled.

31. The method of claim 27, wherein said initial baseline schedule may be an EnergyStar schedule that automatically turns off the HVAC system at a first designated time and turns it on at a second designated time for the user.

32. The method of claim 27, wherein said initial baseline schedule may be a schedule previously produced by the self-programming thermostat.

33. The method of claim 27, wherein said activity parameters comprise of activities such as when the occupant leaves, arrives, sleeps, eats, or bathes in the heated and/or cooled space.

34. The method of claim 27, wherein detected occupancy rates are gathered through detecting changes in occupancy in the heated and/or cooled space.

35. The method of claim 27, wherein said detecting is provided through the use of sensors.

36. The method of claim 35, wherein said sensors is selected from the group consisting of infrared heat sensors, infrared motion sensors, and ultrasonic sensors.

37. The method of claim 27, wherein said variance comprises of capturing consistently changing occupancy rate data of the occupant over a time interval and storing these changed miss times to better reflect changing occupancy patterns by the occupant at said defined activity parameters.

38. The method of claim 27, wherein said miss time is the time when an occupant may be present during unconditioned time of the space or may not be present during conditioned time of the space.

39. The method of claim 27, wherein said miss time is collected and logged through the use of a digital clock and calendar within the thermostat to time stamp when said miss time occurs.

40. The method of claim 27, wherein said time intervals comprises of minute by minute logging of data associated with changes in occupancy rates.

41. The method of claim 40, wherein said time intervals can be optimized by user for longer or shorter time intervals.

42. The method of claim 27, wherein said occupancy rates is configured to provide an occupancy record.

43. The method of claim 42, wherein said occupancy records include occupancy rates for about at least the previous two weeks.

44. The method of claim 27, further comprising converting said occupancy rates into occupancy pattern models to be optimized for the production of said selection of suggested efficient setback schedules for the occupant.

45. The method of claim 27, wherein said average miss time is defined as a proxy for occupant comfort.

46. The method of claim 27, wherein said gradually shrinking setback schedules that gradually minimize miss time on average are generated through the use of two optimization algorithms.

47. The method of claim 46, wherein said two optimization algorithms include: a maximization of Unconditioned Time (UCT) algorithm given user's desired miss time selection and a minimization of average miss time algorithm.

48. The method of claim 47, wherein said maximization of unconditioned time algorithm starts with the maximum possible setback period and uses a sliding window technique to calculate the minimum value of miss time for all schedules with that setback period.

49. The method of claim 48, wherein the maximization of unconditioned time algorithm is applied to all values of desired miss time from about 0 to about 24 hours at fifteen minute intervals and produces a Pareto Optimal curve of setback schedules that maps the longest duration setback period for every possible miss time.

50. The method of claim 48, wherein said sliding window technique gradually shrinks the size of the setback period and repeats until the desired value of miss time by the user is achieved.

51. The method of claim 50, wherein said desired value of miss time is controlled by selection means that allow a user to toggle between at least two suggested efficient setback schedules on said Pareto Optimal Curve and view the tradeoffs between energy and comfort for each suggested setback schedule.

52. The method of claim 51, wherein selection means may include a miss time knob which allows each user to dial into any point on said Pareto optimal curve.

53. The method of claim 47, wherein said maximization of unconditioned time algorithm produces a schedule that achieves said user's desired value of miss time.

54. The method of claim 47, wherein said minimization of average miss time algorithm starts with the schedule produced by the first algorithm and further optimizes it by scanning across the entire accumulated occupancy data set that includes said user variance and generates a schedule that achieves the minimum average value of miss time given the desired miss time selected by user.

55. The method of claim 54, wherein said algorithm optimizes setback schedules to achieve an average miss time aligned with the desired miss time selected by user.

56. A self-programming thermostat control system that automatically creates and suggests highly energy efficient and optimized setback schedules for controlling energy consumption within a space in a controllable and predictable manner intended for a user accordance with consistently changing historical occupancy patterns of a heated and/or cooled space, wherein said system is configured to receive a) occupancy rates associated with different activity functions within the desired heated and/or cooled space and b) captured time intervals when the change of occupancy occurs in the heated and/or cooled space, and wherein said system further comprises:
frequency means for determining the rate and consistency of the received occupancy rates at the captured time intervals that correspond with different user-based activity functions;
storage means for aggregating historical occupancy rates generated by the detecting means in conjunction with the timing and frequency means;
programming means for reading, analyzing, and modeling the collected historical occupancy rates from the detecting means at changing times and frequencies using the timing and frequency means to derive occupancy pattern models that are used to generate and suggest a selection of efficient setback schedules that can be optimized by the user for greater energy efficiency and comfort in a space; and
display means that display a selection of optimal setback schedules generated by using the detecting, timing, frequency, and programming means of the system; that displays information to the user that balances energy usage and comfort; and that contains a selection means which allows a user to choose from the selection of optimal setback schedules for use in the space.

57. The system of claim 56, wherein the programming means of the thermostat analyzes aggregated and stored occupancy rates and converts them into occupancy pattern models to be optimized for the production of at least two of said suggested efficient setback schedules for the user.

58. The system of claim 57, wherein said at least two suggested efficient setback schedules are produced by minimizing desired miss time on average by the user, given occupancy statistics over a time period.

59. The system of claim 56, wherein the display means comprises of selection means that allows the user to toggle between said at least two suggested efficient setback schedules and view the tradeoffs between energy and comfort for each suggested setback schedule.

60. A computer program product comprising a non-transitory computer useable medium having a computer program logic for enabling at least one processor in a computer system to automatically create optimal setback schedules to achieve greater energy efficiency and comfort for an occupant, said computer program logic comprising:
receiving a selected initial baseline setback schedule;
receiving detected occupancy rates of the heated and/or cooled space throughout the cooled and/or heated space over the course of a time interval to generate occupancy patterns, which is defined by activity parameters;
receiving detected and logged variance in said occupancy rates by the occupant at the said defined activity parameters and labeling it miss time;
using said miss time to calculate an average miss time over the course of said time interval;
creating gradually shrinking setback schedules that gradually minimize miss time; and
suggesting a selection of at least two setback schedules with the least said average miss time to the user in an easy to use display model interface with different energy and comfort tradeoffs shown.

61. The computer program product of claim 60, wherein said gradually shrinking setback schedules are generated through the use of two optimization algorithms, which include: a maximization of Unconditioned Time (UCT) algorithm given the user's desired miss time selection and a minimization of average time algorithm.

62. The computer program product of claim 61, wherein said maximization of unconditioned time algorithm starts with the maximum possible setback period and uses a sliding window technique to calculate the minimum value of miss time for all schedules with that setback period.

63. The computer program product of claim 62, wherein the maximization of unconditioned time algorithm is applied to all values of desired miss time from about 0 to about 24 hours at about fifteen minute time intervals and produces a Pareto Optimal curve of setback schedules that maps the longest duration setback period for every possible miss time.

64. A self-programming thermostat control system that automatically senses, creates and suggests highly energy efficient and optimized setback schedules for controlling energy consumption within a space in a controllable and predictable manner for a user in accordance with consistently changing historical occupancy patterns of a space, said system comprises:
a detector, said detector detects occupancy rates;
a timer for capturing said time interval data and for determining the rate and consistency at which the detector detects varying occupancy rates at these different time intervals that correspond with different user-based activity functions;
storage for aggregating historical occupancy rates generated by the detector in conjunction with corresponding said time intervals;
a computer processor for reading, analyzing, and modeling the collected historical occupancy rates from the detector at changing times and frequencies using the timer to derive occupancy pattern models that are used to generate and suggest a selection of efficient setback schedules that can be optimized by the user for greater energy efficiency and comfort in a space; and
a display device that displays a selection of optimal setback schedules generated by using the detecting, timing, frequency, and programming means of the system; that displays information to the user that balances energy usage and comfort, and provides a selection mechanism that allows a user to choose from the selection of optimal setback schedules for use in the space.

65. The system of claim 64, wherein said computer processor analyzes aggregated and stored occupancy rates and converts them into occupancy pattern models to be optimized for the production of at least two of said suggested efficient setback schedules for the user.

66. The system of claim 65, wherein said at least two suggested efficient setback schedules are produced by minimizing desired miss time on average by the user, given occupancy statistics over a time period.

67. The system of claim 65, wherein the display comprises of a selection tool that allows the user to toggle between said at least two suggested efficient setback schedules and view the tradeoffs between energy and comfort for each suggested setback schedule.

68. A self-programming thermostat control system that automatically creates and suggests highly energy efficient and optimized setback schedules for controlling energy consumption within a space in a controllable and predictable manner intended for a user accordance with consistently changing historical occupancy patterns of a heated and/or cooled space, wherein said system is configured to receive a) occupancy rates associated with different activity functions within the desired heated and/or cooled space and b) captured time intervals when the change of occupancy occurs in the heated and/or cooled space, and wherein said system further comprises:
timer for determining the rate and consistency of the received occupancy rates at the captured time intervals that correspond with different user-based activity functions;
storage for aggregating historical occupancy rates;
processor for reading, analyzing, and modeling the collected historical occupancy rates to derive occupancy pattern models that are used to generate and suggest a selection of efficient setback schedules that can be optimized by the user for greater energy efficiency and comfort in a space; and
display unit that displays a selection of optimal setback schedules that displays information to the user that balances energy usage and comfort, and that contains a selection mechanism that allows a user to choose from the selection of optimal setback schedules for use in the space.
